(19) United States
(12) Patent Application Publication
(10) Pub. No.: US 2003/0059758 A1
(43) Pub. Date: Mar. 27, 2003

(54) Enhanced reading system and method

(76) Inventors: Brett Cohen, Philadelphia, PA (US); Jeffrey Tannenbaum, Philadelphia, PA (US)

Correspondence Address: Stephen J. Weed, Esq., SYNNESTVEDT & LECHNER LLP, 2600 Aramark Tower, 1101 Market Street, Philadelphia, PA, 19107, US

(21) Appl. No.: 09/791,232

(22) Filed: Feb. 23, 2001

Related U.S. Application Data
(60) Provisional application No. 60/184,369, filed on Feb. 23, 2000.

(51) Int. Cl. G09B 5/00

(52) U.S. Cl. 434/317

(57) ABSTRACT

A reading system and method. The system and method integrate a printed book and associated interactive electronic data stored on a remote database. The printed book contains indicia to identify the location of the interactive electronic data. In addition, visual cues are disposed throughout the printed book to indicate the availability of electronic data associated with printed material located in the proximity of the visual cue. A reader of the printed book employs the indicia and the visual cues to accesses the interactive electronic data.

### CROSS-REFERENCE TO RELATED APPLICATIONS

This application is based on, and claims priority to, U.S. Provisional Application No. 60/184,369, filed Feb. 23, 2000.

### FIELD OF THE INVENTION

The present invention relates generally to multimedia publishing, and more particularly to an interactive multimedia system in which printed materials are enhanced with electronic media stored on a remote database.

### BACKGROUND OF THE INVENTION

Printed books are a major medium for distributing information and providing entertainment. Presently, individuals are turning to electronic media, such as television and the Internet, for their information and entertainment. Electronic media is attractive because of its ability to engage the individual with a combination of sight, sound, and interactivity. Printed books, however, are able to provide an experience which cannot be duplicated by electronic media and reading them remains a pleasurable activity for many. In addition, well-established manufacturing facilities and complete distribution chains are already in existence for producing and distributing printed books. Accordingly, a system and method capable of enhancing printed books with engaging media-rich material while retaining the experience of printed books and utilizing existing production facilities and distribution channels would be desirable.

There have been several approaches to enhancing printed books. One approach involves combining printed books with electronic media in a training system. In this type of system, a printed course book is provided in combination with multimedia content stored locally on a hard disk, floppy disk, or CD-ROM, or on a remote database accessible via the Internet. The printed course book and multimedia materials parallel one another. The multimedia used to enhance the printed materials is predominately informational, e.g., images, sounds, and supplemental text related to portions of text within the printed text. Although informative, this type of enhancement falls short of fully engaging the reader through an interactive experience. In addition, the experience is essentially one-directional in which the multimedia materials enhance the book but do not alter the reading flow of the text within the book.

U.S. Pat. No. 5,954,515 to Iggulden, incorporated fully herein by reference, discloses an approach in which a printed book is augmented with electronic data, e.g., images, sounds, and/or supplemental text, stored on a remote server. Visual cues within the text of the printed book are associated with the images, sounds, and supplemental text. The approach used in Iggulden provides a graphical user interface for controlling access to the stored electronic data. When a reader of the printed book wishes to access data associated with a portion of the text, the user uses a computer pointing device to select or manipulate an indicator on the graphical user interface corresponding to the visual cue in the book. The electronic data is retrieved and presented to the reader as images, sounds, and supplemental text.

Although the approach in Iggulden provides a form of enhanced reading, it does not provide for engaging interactivity between a reader of the printed book and the electronic media. In addition, as in the training systems, Iggulden is essentially a one-directional approach since the electronic media does not affect the reading flow of the printed book.

The related art fails to provide a truly interactive and fully engaging reading experience in which a printed book is enhanced with interactive electronic media. In addition, the related art presents a one-directional approach in which printed materials are enhanced with electronic media without the electronic media having an effect on the reading of the printed book. Accordingly, a truly interactive two-directional system combining a printed book and electronic media capable of fully engaging the reader would be useful.

### SUMMARY OF THE INVENTION

The present invention relates to an enhanced reading system and method capable of fully engaging a reader. The present invention accomplishes this by providing a printed book and associated electronic data. The electronic data is interactive electronic data stored on a remote database. Individual portions of the interactive electronic data correspond to portions of the printed book to create an engaging reading experience. The individual portions of the interactive electronic data include supplemental text, images, sounds, multimedia, and/or multimedia animation which relate to portions of the printed book.

The printed book contains an emblem which indicates the location of the interactive electronic data and visual cues dispersed throughout the book which correspond to specific portions of the interactive electronic data. The specific portions relate to the printed material in the proximity of the visual cues. Using a computer, the reader employs the emblem and the visual cue to access the individual portions of the interactive electronic data. An interface is provided for reader interaction with the individual portions of the interactive electronic data. After interacting, the reader returns to reading the printed book. The integration of the printed book and the interactive electronic data in accordance with the present invention results in an interactive reading experience.

In an embodiment of the present invention, the interaction between the reader and electronic data results in the electronic data providing a return point which is a function of the interaction. The return point instructs the reader to resume reading the printed book at a specific point within the book, a point not necessarily where the reader stopped reading the printed book at the time the reader accessed the electronic data. By using the interactive electronic data to specify a return point in the printed book, a truly interactive two-directional reading experience, capable of fully engaging the reader, is achieved.

### BRIEF DESCRIPTION OF THE DRAWINGS

FIG. 1A is a block diagram depicting an embodiment of the enhanced reading system in accordance with the present invention.

FIG. 1B is an illustration depicting a page of the printed book of FIG. 1A having sample text and a visual cue in accordance with the present invention.

FIG. 1C is an illustration depicting interactive electronic data associated with the sample text of FIG. 1B in accordance with the present invention.

FIG. 2 is a flowchart illustrating the interaction between the printed book and electronic data of FIGS. 1A-1C in accordance with the present invention.

FIG. 3 is a flowchart used to describe an enhanced reading method in accordance with the present invention.

### DETAILED DESCRIPTION OF THE INVENTION

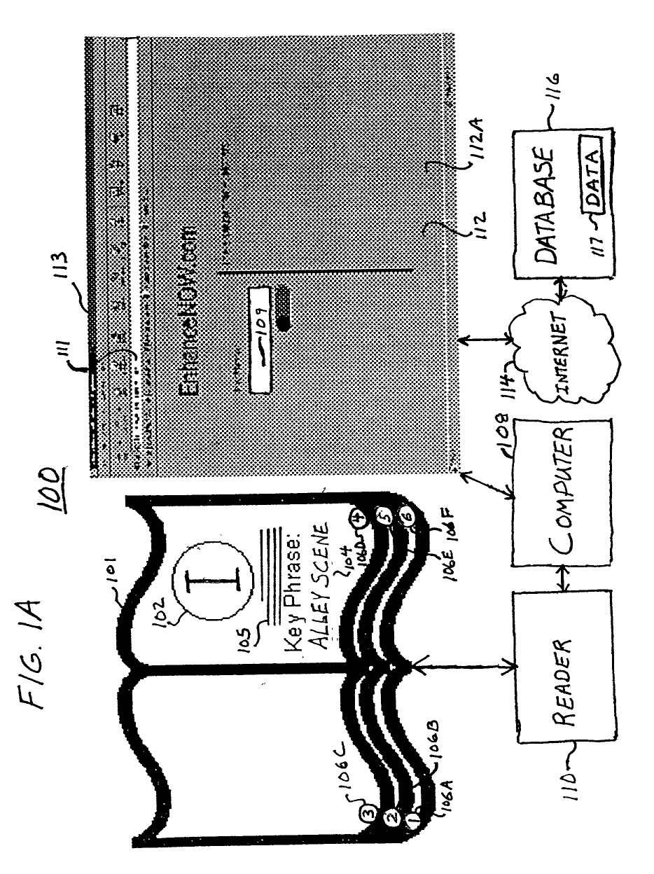

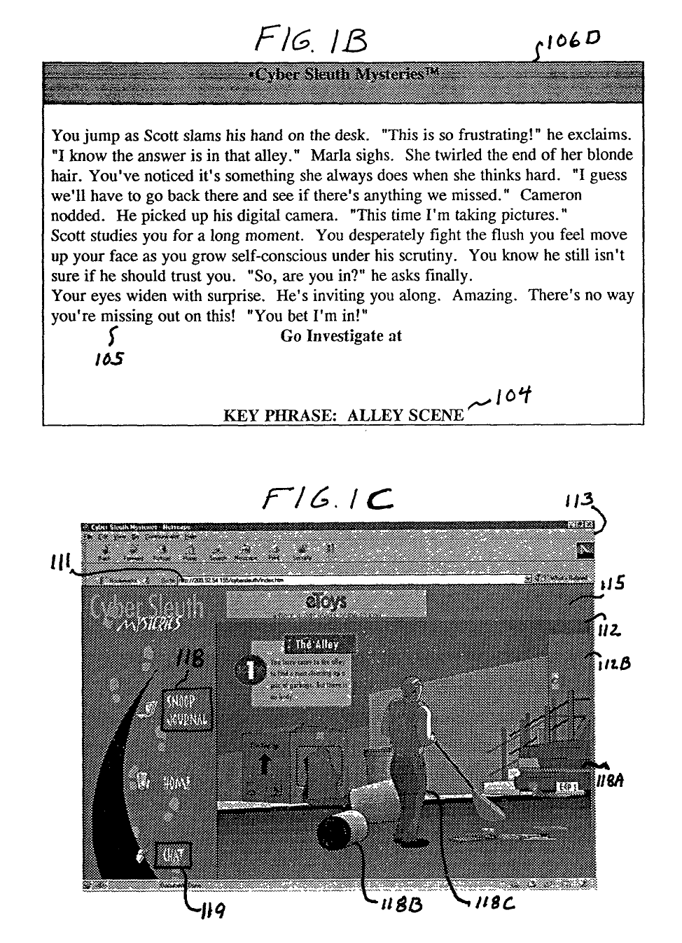

FIG. 1A depicts a preferred embodiment of an enhanced reading system 100 in accordance with the present invention. The system 100 includes a printed book 101 and interactive electronic data 117 stored on a remote database 116. A reader 110 of the printed book 101 accesses the electronic data 117 via the Internet 114 using a browser 113 running on a computer 108. By integrating the printed book 101 with the interactive electronic data 117, the system 100 is capable of fully engaging the reader 110 of the printed book 101, thereby enhancing the reader's experience.

In a preferred embodiment, the printed book 101 is essentially an ordinary book with a plurality of pages 106A-F containing printed material. In an alternative embodiment, the printed book 101 is an electronic book electronically displayed on a computing device, e.g., a personal computer, mainframe computer, personal digital assistant or other type of electronic device capable of displaying text and/or graphics.

The printed book 101 is imprinted with an emblem 102 (hereinafter referred to as indicia 102) on its cover and/or on at least one of the plurality of pages 106A-F. Alternatively, the indicia 102 is printed on associated materials, e.g., dust jacket, packaging materials, or other items commonly associated with the printed book 101. The indicia 102 is a symbol, icon and/or text indicating to a reader 110 that supplemental interactive electronic data 117 related to the printed book 101 as a whole is available at the remote database 116 and, optionally, indicating how to access the remote database 116.

In addition, the printed book 101 contains one or more visual cues 104, e.g., a key phrase, indicating the availability of supplemental electronic data 117 related to printed materials incident to the visual cues 104, such as sample text 105. The visual cues 104 appear in proximity to the printed materials for which there is associated electronic data 117. The printed materials include text, pictures, graphs, charts, or other type of printed material within the printed book 101. In one embodiment, the visual cue 104 is integrated into the text of the printed book 101, such as, for example, one or more words of the text printed in boldface type or in a contrasting font color. In another embodiment, the visual cue 104 is located proximate to the printed materials within the printed book 101. Preferably, the visual cue 104 is readily apparent to the reader 110 of the printed book 101.

The illustration in FIG. 1B is a detailed depiction of a page 106D within the printed book 101 of FIG. 1A. The page 106D contains text 105 and an associated visual cue 104, “KEY PHRASE: ALLEY SCENE.” The visual cue 104 indicates to the reader 110 that interactive electronic data 117 is available at a remote location which corresponds to the text 105.

The remote database 116 stores the interactive electronic data 117 associated with the printed book 101 of FIG. 1A. Such interactive electronic data 117 may be in the form of images, sounds, supplemental text, multimedia, and/or multimedia animation. The interactive electronic data may include activities for the reader 110 such as solving puzzles, investigating crime scenes, interrogating witnesses, taking notes in an electronic journal, identifying suspects, gathering clues, collaborating with other readers, chatting with other readers, enrolling in contests, purchasing goods and services, or performing other activities. In addition, the interactive electronic data 117 may be used to solicit information from the reader 110 such as preferences and characteristics. The remote database 116 is of a conventional design, and the selection and configuration of an appropriate database for use with the present invention will be readily apparent to those skilled in the art. The remote database 116 is accessed via a network using the computer 108. The computer 108 is a personal computer, mainframe computer, personal digital assistant, or essentially any device capable of transmitting, receiving, and displaying information.

In a preferred embodiment, the interface 112 is a web page used to display and interact with the interactive electronic data 117 stored on the remote database 116. The interface 112 is developed using conventional programming techniques which are well known in the art. The main interface 112A is accessed via the Internet 114 by inserting a web address (derived from the indicia) into the address field 111 of a conventional web browser 113 running on the computer 108. Preferably, the indicia 102 includes a World Wide Web (web) address which the reader 110 employs inherently, due to the wide-spread familiarity with web addresses and web browsers, to access the remote database 116 via the Internet 114 by typing the web address into a conventional web browser 113 running on the computer 108. Alternatively, the reader 110 is instructed on how to use the indicia 102 through printed information within the book 101, materials associated with the book 101, word of mouth, advertising, or some other form of communication. Upon initial access to the remote database 116, the web browser 113 displays a main interface 112A.

The reader 110 then supplies the main interface 112A with the visual cue 104 to access interactive electronic data 117 associated with the printed material in the proximity of the visual cue 104. The interactive electronic data 117 is displayed in the form of a web page on the web browser 113. The interactive electronic data 117 responds to the actions of the reader 110. For example, if a door is displayed on an interface 112, pointing to the door with a selection device, e.g., a mouse, will open the door, and the reader 110 will be presented with additional interactive electronic data 117. Access to the interactive electronic data 117 and interaction with the data 117 is implemented using conventional programming techniques.

FIG. 1C illustrates a sample electronic data image 115 associated with the sample text 105 of FIG. 1B. The image 115 is an alley scene 112B which corresponds to the sample text 105 on page 106D. The alley scene 112B is presented on the interface 112 running on the web browser 113 of FIG. 1A. The alley scene 112B is accessed by inserting a representative portion of the visual cue 104, e.g., “ALLEY SCENE,” into an entry field 109 of the main interface 112A depicted in FIG. 1A. The electronic material is responsive to the reader 110 entering the visual cue 104 into the entry field 109. Alternatively, the visual cue 104 may be identified by selecting from a drop-down menu or other selection process. Suitable selection processes will be readily apparent to those in the art.

Using a selection device, the reader 110 interacts with the sample electronic data 115, by manipulating screen items on alley scene 112B. The sample electronic data 115 can be manipulated and additional electronic data 117 can be retrieved during the interaction. In one embodiment, the system is configured to allow the reader 110 to take electronic notes by selecting an electronic journal 118 or chat with other readers who are online by selecting a chat feature 119.

Accordingly to one embodiment, after interacting with the electronic data 117, the electronic data 117 instructs the reader 110 to resume reading of the printed book 101 at a return point. The return point is an identified location within the printed book 101 which is selected by the interactive electronic data 117 based on the interaction between the reader 110 and the electronic data 117. Identified locations are disposed throughout the plurality of pages 106A-F (FIG. 1A). The identified locations may be page numbers, chapter headings, section heading, or essentially any identifier capable of identifying a location within the printed book 101. The return point may, but need not be, the location in the book 101 where the reader 110 was prompted to access the electronic data 117. The return point may be a location in the book 101 prior to or after the point in the book 101 where the reader 110 was prompted to access the electronic data 117. The return point is implemented using conventional programming techniques.

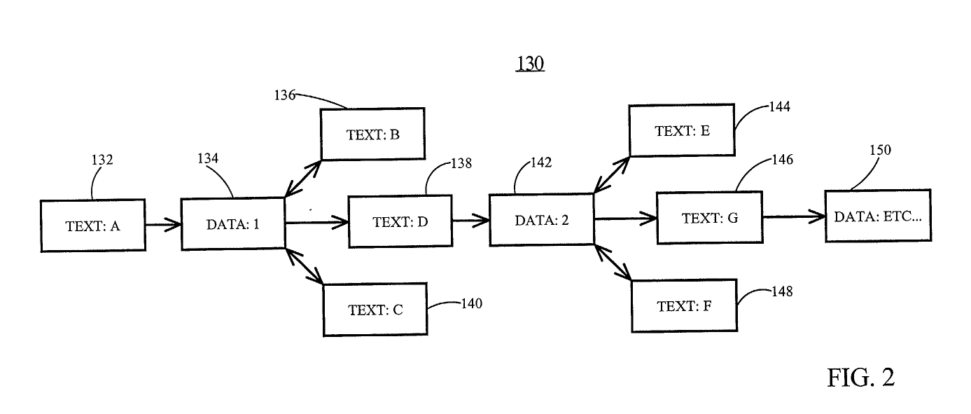

FIG. 2 illustrates the interaction between the printed book 101 having an indicia 102 and the interactive electronic data 117, and the concept of a return point based on the interaction. In FIG. 2, a reader begins by reading TEXT:A 132 of the printed book 101. For illustrative purposes, the TEXT:A 132 may introduce the characters, setting, and main events of the printed book 101. While reading the TEXT:A 132, the reader 110 encounters one of the visual cues 104 within the printed book 101 (FIG. 1A), indicating that supplemental electronic data 117 is available at the remote database 116. The reader 110 employs the indicia 102 and visual cue 104 to access the DATA:1 134 using the techniques described above.

The reader 110 interacts with the DATA:1 134 through the interface 112 displayed on web browser 113 using the computer 108 (FIG. 1A). For example, the reader 110 will view and interact with a scene, such as alley scene 112A (FIG. 1C), displayed on the interface 112. The reader 110 can investigate an object, such as automobile 118A or trash can 118B, or interrogate a witness/suspect 118C. In addition, the reader 110 may uncover secret passage ways, which, when selected, alter the alley scene 112A or display a new scene with which the reader 110 may interact. The reader 110 interacts with the alley scene 112A using conventional computer techniques such as selecting by “clicking” on the object 118A or the witness/suspect 118C, using “drag and drop” features, or choosing from a drop down menu among other techniques.

The interaction with DATA:1 134 proceeds until the reader 110 has found an amount of information. The system may force the reader 110 to leave the scene 112A or the reader 110 may leaves the scene 112A voluntarily. The reader may be forced to leave the scene 112A if a predetermined amount of information has been found or after a predetermined period of time has passed. Upon completion of the interaction with DATA1: 134, the DATA:1 134 may instruct the reader 110 to resume reading the printed book 101 at either TEXT:B 136, TEXT:C 140, or TEXT:D 138. The selection of TEXT:B 136, TEXT:C 140, or TEXT:D 138 by the DATA:1 134 is dependent on the reader's 110 interaction with the DATA:1 134. For example, if the reader 110 fails to uncover some of the information in the alley scene 112A, the DATA:1 134 will prompt the reader 110 to resume reading at the TEXT:B 136 or TEXT:C 140 of the printed book 101 depending on the information found. The TEXT:B 136 and TEXT:C 140 will eventually direct the reader 110 to return to the DATA:1 134 for more interaction with the alley scene 112A so that the reader 110 may uncover additional information. Hints may be supplied in TEXT:B 136 of TEXT:C 140 to assist the reader 110 in uncovering information in DATA:1 134. In one embodiment, upon returning to the DATA:1 134, the alley scene 112B changes thereby representing the passage of time. For example, the automobile 118A may no longer be in the alley scene 112A, and upon interaction with the DATA:1 134, the reader 110 will uncover that the automobile 118 has been impounded. The reader 110 will then have the option of going to an electronic version of an impound lot to search the automobile 118A. This example is provided for illustrative purposes only and variations and alterations will be readily apparent to those in the art.

When the reader 110 uncovers the predetermined amount of information, however, the DATA:1 134 will prompt the reader 110 to resume reading at the TEXT:D 138 which will progress the reader 110 through the printed book 101 and eventually result in the reader 110 reaching the end of the printed book 101 or being prompted to interact with the DATA:2 142. The reader's 110 interaction with the DATA:2 is similar to the interaction described above for the DATA:1, resulting in the reader 110 being instructed to return to either the TEXT:E 144, TEXT:F 148, or TEXT:G 146 of the printed book 101. After the reader 110 is instructed to read TEXT:G 146, the printed book 101 either ends or directs the reader 110 to the DATA:ETC 150. The number of text and data portions is for illustrative purposes and will vary from book to book.

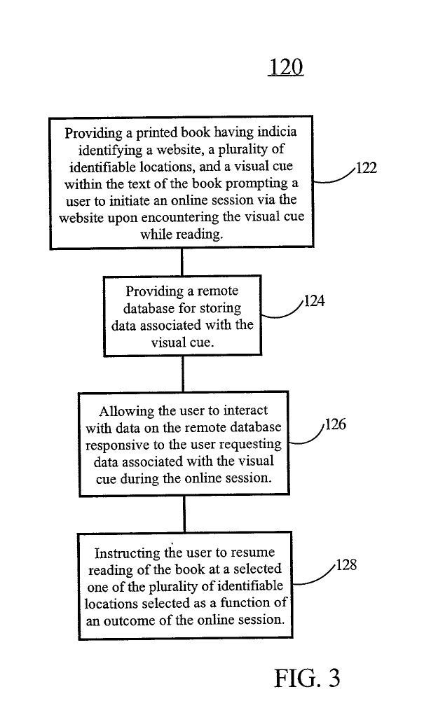

A method for implementing the preferred embodiment of the present invention is illustrated in FIG. 3. In step 122, the printed book 101 (FIG. 1) is provided. The printed book 101 containing the indicia 108 identifying a website, the plurality of identifiable locations within the printed book 101, and the visual cue 104. The visual cue 104 prompts the reader 110 to initiate an online session via the Internet 114 upon encountering the visual cue 104 while reading the printed book 101. In a preferred embodiment, the online session is a conventional connection to a database 116 via the Internet 114 however, it will be apparent to those skilled in the art that the online session could be an intranet session or some other type of network session.

In step 124, the remote database 116 is provided for storing interactive electronic data 117 associated with the visual cue 104. The reader 110 is allowed to interact with the interactive electronic data 117 in step 126. The data 117 is displayed on the computer 108 in response to the reader 110 requesting data associated with the visual cue 104 during the online session. In one embodiment of the present invention, upon completion of the online session, the reader 110 is instructed to resume reading the printed book 101 at a selected one of the plurality of identifiable locations, in step 124. Preferably, the identifiable location is selected as a function of the outcome of the online session. Alternatively, the reader 110 resumes reading at the point in the printed book where the reader 110 was prompted to initiate an online session.

Having thus described a few particular embodiments of the invention, various alterations, modifications, and improvements will readily occur to those skilled in the art. For example, the preferred embodiment was implemented using conventional hardware and programming techniques, however, it will be readily apparent to those skilled in the art that the inventive concepts will be applicable to other types of hardware and programming now known or later developed. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. An interactive multimedia system comprising:
a printed book having a plurality of pages of text and one or more visual cues on said plurality of pages of text wherein each of said visual cues is associated with interactive electronic data stored on a remote database;
indicia associated with said printed book capable of identifying the location of said interactive electronic data; and
an interface for interacting with said interactive electronic data.

2. An interactive multimedia system comprising:
a printed book containing plural pages of text, an indicia associated with said printed book, and visual cues in the proximity of said plural pages of text;
a remote database for storing interactive electronic data associated with said visual cues, each of said visual cues associates with a portion of said interactive electronic data;
an interface for accessing and displaying said portions of said interactive electronic data by receiving representative portions of said visual cues from a reader of said printed book, said interface further used for allowing interaction between said portions of said electronic data and said reader; and
wherein upon coming across one of said visual cues, said reader accesses associated portions of said interactive electronic data by supplying said representative portion of said one of said visual cues into said interface, said reader then interacts with said associated portions of said interactive electronic data displayed by said interface.

3. The system of claim 2, wherein upon the completion of said associated portions, said reader is directed to a return point within said printed book.

4. The system of claim 3, wherein said return point is dependent on said readers actions during interaction with said associated portions of said interactive electronic data.

5. An interactive multimedia method comprising the steps of:
providing a printed book containing a plurality of pages of text and visual cues on said plurality of pages of text, each of said visual cues associated with interactive electronic data on a remote database, said interactive electronic data having a plurality of portions;
providing indicia associated with said printed book for identifying the location of said remote database; and
providing an interface for receiving a representative portion of a first one of said visual cues, permitting a reader to interact with one or more portions responsive to receiving representative portion of said first one of said visual cues, and displaying information generated by said portions of said interactive electronic data;
wherein upon encounter said first one of said visual cues, in said printed book said reader accesses associated portions of said electronic data by inputting said representative portion of said first one of said visual cues into said interface, said reader then interacts with said associated portions of said electronic data displayed by said interface.

6. The method of claim 5, wherein said portions of said electronic data comprise images, sound, supplemental text, multimedia, and multimedia animation.

7. The method of claim 5, wherein said first one of said visual cues is a key phrase, said key phrase comprising one or more alphanumeric characters.

8. The method of claim 7, wherein said indicia comprises a web address identifying the location of said remote database.

9. The method of claim 5, further comprising the step of soliciting information from said reader using said interactive electronic data and storing said information in said remote database.

10. The method of claim 5, wherein said interactive electronic data comprises activities for said reader.

11. The method of claim 10, wherein said reader activities are selected from a group consisting of solving puzzles, investigating crime scenes, interrogating witnesses, taking notes in an electronic journal, identifying suspects, gathering clues, collaborating with other readers, chatting with other readers, gaming with other readers, enrolling in contests, and purchasing goods and services.

12. The method of claim 5, wherein upon the completion of one of said associated portions, said reader is directed to a return point within said printed book, said return point selected as a function of said user's interaction with said one or more of said plurality of portions associated with said first one of said visual cues.

13. An interactive multimedia method comprising the steps of:
providing a printed book with a plurality of pages of text, each of said plurality of pages of text being individually identifiable, said printed book containing indicia and one or more visual cues;
storing electronic data associated with said one or more visual cues in a remote database, the location of said remote database identified by said indicia;
storing a program in said remotely database, said program controlling access by a reader of said printed book to said electronic data, interfacing with said reader, and generating a return point, said return point, selected as a function of said reader interaction, indicating at which of said individually identifiable pages of text a reader should resume reading; and
providing an interface for said reader to interact with said program;
wherein upon encountering a first one of said one or more visual cues while reading, said reader accesses said associated electronic data by inputting a representative portion of said first one of said one or more visual cues into said program through said interface, interacts with said electronic data through said interface, and receives said indicator indicating one of said individually identifiable pages of text, said indicator selected as a function of said interaction with said reader.

14. An interactive multimedia method comprising the steps of:
providing a printed book having indicia identifying a website, a plurality of identifiable locations, and a visual cue within the text of said printed book prompting a user to initiate an online session via said website upon encountering said visual cue while reading said printed book;
providing a remote database for storing data associated with said visual cue; and
allowing said user to interact with said data associated with said visual cue on said remote database, said remote database responsive to said user requesting data associated with said visual cue and said user's actions during said online session.

15. The method of claim 14, further comprising the step of instructing the user to resume reading of said printed book at a selected one of said plurality of identifiable locations, said selected one of said plurality of identifiable locations selected as a function of an outcome of said online session.
